(19) United States
(12) Patent Application Publication
(10) Pub. No.: US 2024/0367259 A1
(43) Pub. Date: Nov. 7, 2024

(54) WELDING OPTICAL UNIT WITH BEAMFORMING INSERT, AND WELDING APPARATUS

(71) Applicant: TRUMPF Laser GmbH, Schramberg (DE)

(72) Inventors: Patrick Haug, Unteriflingen (DE); Daniel Flamm, Ludwigsburg (DE); Christoph Tillkorn, Villingendorf (DE)

(21) Appl. No.: 18/773,612

(22) Filed: Jul. 16, 2024

Related U.S. Application Data
(63) Continuation of application No. PCT/EP2023/050509, filed on Jan. 11, 2023.

(30) Foreign Application Priority Data
Jan. 18, 2022 (DE) 10 2022 101 091.0

(51) Int. Cl. B23K 26/06; B23K 26/067; B23K 26/073

(52) U.S. Cl. CPC B23K 26/0648; B23K 26/0676; B23K 26/0734

(57) ABSTRACT

A welding optical unit for shaping a processing beam of a processing head of a welding apparatus includes a collimation lens, a focusing lens, and a beamforming insert for forming one or more spots of the processing beam on at least one workpiece to be processed. The beamforming insert has a base face and one or more side faces lying opposite the base face, which converge at a common point or in a common plateau of the beamforming insert.

### CROSS REFERENCE TO RELATED APPLICATIONS

This application is a continuation of International Application No. PCT/EP2023/050509 (WO 2023/138959 A1), filed on Jan. 11, 2023, and claims benefit to German Patent Application No. DE 10 2022 101 091.0, filed on Jan. 18, 2022. The aforementioned applications are hereby incorporated by reference herein.

### FIELD

Embodiments of the present invention relate to a welding optical unit and to a welding apparatus.

### BACKGROUND

For standard applications in the welding of copper and steel materials, for example the welding of so-called hairpins to stators of electric motors and of so-called can caps to so-called cans of batteries, standard welding with a singular spot and welding with a singular spot by using the technology marketed by TRUMPF Laser-und Systemtechnik GmbH under the brand name “BrightLine Weld” are known.

In the case of aluminium materials (profile welding), the use of bifocal spots for linear weld seams is also known, which takes place direction-dependently and in which the spacings between the spots may be fixed or variably adjustable. Furthermore, welding with quatro-spots is known for the direction-independent welding of aluminium workpieces (for example heat exchangers, die casting), although in this case the spacings between the spots are fixed.

Various welding methods adapted to different welding situations or applications, in which one, two or four spots are used, are therefore known.

It is desirable to provide a simple and economical welding method that provides an optimum welding outcome for different welding situations or applications.

### SUMMARY

Embodiments of the present invention provide a welding optical unit for shaping a processing beam of a processing head of a welding apparatus. The welding optical unit includes a collimation lens, a focusing lens, and a beamforming insert for forming one or more spots of the processing beam on at least one workpiece to be processed. The beamforming insert has a base face and one or more side faces lying opposite the base face, which converge at a common point or in a common plateau of the beamforming insert.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic cross-sectional view of a welding apparatus according to one exemplary embodiment of the invention during a welding process,

FIGS. 2a, 2b, 3a, 3b, 4a, 4b, 5a, 5b, 6a, 6b and 6c show perspective views of different embodiments of beamforming inserts for the welding optical unit of the welding apparatus of FIG. 1,

FIGS. 7a, 7b and 7c show intensity distributions of processing beams of different welding optical units of FIG. 2a-6c in the welding apparatus of FIG. 1, according to some embodiments, and

FIGS. 8a, 8b, 8c and 8d show intensity distributions of processing beams of the same welding optical unit with different distances between the welding optical unit and the collimation lens in the welding apparatus of FIG. 1, according to some embodiments.

### DETAILED DESCRIPTION

Embodiments of the invention provide an improved welding method, which in particular can be carried out as simply and flexibly as possible.

Accordingly, a welding optical unit for shaping a processing beam of a processing head of a welding apparatus is provided, the welding optical unit comprising a collimation lens and a focusing lens. The welding optical unit further comprises a beamforming insert for forming a number n of spots of the processing beam on at least one workpiece to be processed. The beamforming insert has a base face and a plurality k≥3 of side faces lying opposite the base face, which converge at a common point or in a common plateau of the beamforming insert.

The beamforming insert formed with the at least three side faces is a economical and simple way of dividing the processing beam of the processing head between the number n of spots and thereby improving the weld quality during the welding of different materials and workpiece geometries. It is merely necessary to change the welding optical unit in a corresponding welding apparatus in order to configure the welding apparatus with the welding process thereby made possible with the number n of spots.

The beamforming insert has a point or a plateau at which the k side faces converge, that is to say intersect. The point or the plateau lies opposite the base face. The point or the plateau may have the greatest distance from the base face of any point inside the beamforming insert. The point does not generate a separate spot, so that the number k of side faces may correspond to the number n of spots, whereas an additional spot, in particular a central spot, is generated in the case of a plateau. The plateau may also be described as a plane or upper side, which forms an additional face that connects the side faces to one another opposite to the base face. The plateau may for example have a round, rectangular, in particular square, polygonal or similar shape.

The number of spots and/or the arrangement of the spots relative to one another may respectively be predefined, in particular determined by the geometry of the beamforming insert, in particular the number and arrangement of the side faces, as will be explained in more detail below. Correspondingly, the number and special arrangement of the spots may be varied by a simple change of the entire welding optical unit or of the beamforming insert, which provides a high degree of flexibility for adapting the welding method to different welding situations and applications.

The side faces are in particular respectively arranged adjacent to one another, or next to one another. Neighbouring side faces may correspondingly each share a side with one another. In particular, the side faces may extend upwards from the base face, more particularly in the direction of a common point, for instance an apex, where they touch. The side faces may respectively be set at an angle in relation to the base face in order to converge at the common point or plateau. More particularly, the angle may be not equal to 90°. The angle may further be the same for each side face.

The plurality k of side faces (in particular together with the base face) may substantially form a pyramid shape or a cone shape of the beamforming insert. In the case of a cone shape, there are quasi-infinitely many, or at least a very large number of side faces, for example 20, 50, 100 or more, so that the cone shape, in particular an axicon as the beamforming insert, is formed. In order to form the pyramid shape or cone shape, the side faces may respectively converge at the common point, particularly in the form of an apex, as explained above.

The number n of spots may be a plurality of n≥3 spots or a substantially annular spot. A spot of the processing beam may in each case be formed on the at least one workpiece to be processed, or a workpiece to be welded to another workpiece, respectively by a side face of the beamforming insert. The number of spots may thus be n=3 in the case of k=3 side faces. The number of spots may nevertheless also be more than n=3, for example n=4, n=5 or more, so that a larger number of side faces is also involved. Side faces mean in particular those faces of the beamforming insert that extend between a base face and the apex lying opposite the latter, or the plateau of the beamforming insert. In the case of an annular spot, such as may be formed in particular by a beamforming insert with a cone shape, more particularly in the form of an axicon, there are a multiplicity of spots which are combined together to form the ring shape.

The side faces may each have a three-sided geometry. Depending on the shape of the base face of the pyramid, for example round or circular or quadrilateral, the three-sided geometry may be configured to be triangular or with two straight sides and one round side.

The welding optical unit may, for example, be a fixed optical unit or a scanner optical unit. A scanner optical unit may be equipped with one or more mirrors, by means of which the processing beam can be deviated in a scan field of the scanner optical unit. The processing beam may thereby be moved even without relative movement of the processing head in relation to the at least one workpiece, in order to form the desired weld seam. Alternatively or in addition, however, a corresponding movement device may naturally be provided for movement of the processing head and/or of the at least one workpiece.

Preferably, the beamforming insert is arranged before the collimation lens and the focusing lens in a beam propagation direction of the processing beam. In other words, the beamforming insert may be arranged between the beam source (of the welding apparatus), for example with a fibre-optic cable guided therein, and the collimation lens. This allows displaceability of the beamforming insert relative to the collimation lens in order to vary the spacings of the individual spots from one another. Alternatively, for example, it is possible to arrange the beamforming insert between the collimation lens and the focusing lens.

Correspondingly, it is advantageous for the beamforming insert to be coupled with a displacement device that is adapted to displace the beamforming insert along a beam propagation axis of the processing beam and/or relative to the collimation lens. The beamforming insert can thus be displaced along the displacement axis of the displacement device, which coincides with the beam propagation axis, in order to vary the spacings of the individual spots, or the beam axes of the individual spots. The displacement device may be equipped with a drive, for example an electrical drive. Further, the displacement device may be coupled or equipped with a control device in order to control the displacement of the beamforming insert automatically. By this flexibility in the adjustment of the spot spacings for the respective welding situation, which may for example be determined by material and workpiece thicknesses, in particular sheet-metal thicknesses, the process reliability may also be increased and high-quality weld seams may be ensured.

It is further advantageous that a media-tight weld may be generated during the welding of aluminium materials. When a beam deviating device, in particular a scanner device, is used in the welding optical unit, or the welding apparatus, more favourable system technology may also be used since highly dynamic axis kinematics can be obviated by virtue of the adjustability of the spot spacings by means of the displacement device. Advantageously, it is also possible to use welding process control loops by which critical locations such as narrow welding radii can be separately parameterized or regulated.

It is also advantageous for the number n of spots to be at least equal to the number k of side faces. If the beamforming insert has k=4 side faces, for example, then the number n of spots is also at least n=4 or more. More particularly, the number n of spots may also correspond to the number k of side faces.

It is advantageous in this case for the number k of side faces to be at least or exactly k=4. The number n of spots may therefore in particular also be n=4. A symmetrical multispot processing beam with 4 spots is thereby provided, which enables substantially direction-independent processing, or welding.

In particular applications, it may be advantageous for the beamforming insert to be frustopyramidal or frustoconical. In other words, the pyramid shape of the beamforming insert is a pyramidal frustum, i.e. a pyramid with a flattened upper side or plateau instead of a point, or a conical frustum, i.e. a cone with a flattened upper side or plateau instead of a point. The flat upper side, or the plateau, then generates a further central spot in the middle between the other spots, which are then located around the central spot on the workpiece to be processed.

In the embodiment of the beamforming insert in which the side faces converge at the common point, the point may in particular be an apex or an indentation of the beamforming insert.

Preferentially, furthermore, the beamforming insert has a substantially plane base face.

The beamforming insert may have a round, in particular circular, base face. Alternatively, other base faces, in particular n-gonal, for example rectangular, square, triangular, etc., are possible. Correspondingly, the beamforming insert may for example have a pyramid shape or a cone shape with a round or polygonal base face. The beamforming insert may for example be composed of a plurality of elements, in particular wedge-shaped elements (or wedge plates), for instance by optical contact bonding of the elements or by means of an optical holder.

The object mentioned in the introduction is further achieved by a welding apparatus according to claim 13. Accordingly, a welding apparatus for joining at least two workpieces is proposed, comprising: a processing head for directing a processing beam onto the at least two workpieces, and the welding optical unit as described above.

It is also possible, as described above, for the welding optical unit to be configured as a scanner optical unit, that is to say configured with one or more mirrors for deviating the processing beam, and/or for the welding apparatus to comprise a movement device for moving the processing beam and the at least two workpieces relative to one another along a forward feed direction while forming a weld seam.

Furthermore, the processing head may comprise a laser fibre-optic cable having an inner fibre core and an outer fibre core, which in particular may be annular. Such an arrangement is also referred to as a multiclad fibre. In order to generate the processing beam in the case of such a fibre, or such a laser fibre-optic cable, an initial laser beam may be launched into a first end of the multiclad fibre, in particular of a 2-in-1 fibre, in which case the multiclad fibre may comprise at least one core fibre and a ring fibre enclosing the latter. A first part of the laser power of the initial laser beam may be launched into the core fibre and a second part of the laser power of the initial laser beam may be launched into the ring fibre. A second end of the multiclad fibre may then be steered onto the processing surface of the workpieces.

Further, the processing head may comprise a cable connector for the laser fibre-optic cable, which can be adjusted in relation to the collimation lens, in particular transversely with respect to the latter. In addition or alternatively, the beamforming insert may be adjustable in relation to the cable connector of the laser fibre-optic cable, in particular by means of a corresponding adjustment apparatus. In this way, the processing beam, or the beam propagation axis, can be aligned simply with respect to the welding optical unit.

The welding optical unit according to embodiments of the invention and the welding apparatus according to embodiments of the invention may each be usable in particular for the laser welding of metallic workpieces (for example workpieces containing iron, aluminium or copper). For the laser welding, the deviated partial beams of the processing beam are focused onto the workpiece surface to be processed. In other words, the spots are formed in the focused processing beam. In particular, the welding optical unit and/or the welding apparatus may be configured to carry out a welding method in which a common weld pool or a plurality of mutually separate weld pools is or are generated by the n spots of the (focused) processing beam, so that a resulting common weld seam with a continuous weld bead is created.

Exemplary embodiments of the invention are described and explained in more detail.

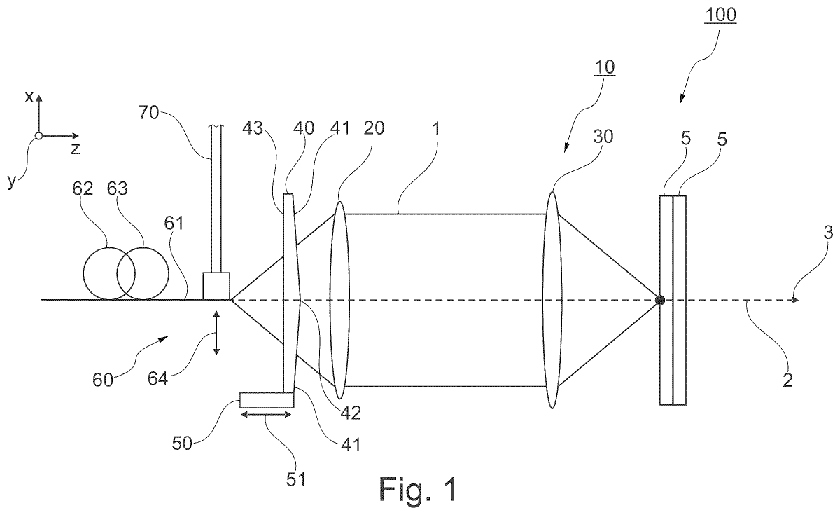

FIG. 1 shows an exemplary structure of a welding apparatus 100 for joining two workpieces 5 by means of a processing beam 1 in the form of a laser beam. In order to generate the processing beam 1, or laser beam, the welding apparatus 100 may comprise a beam source in the form of a laser source (not shown), for example in the form of a solid-state laser, for example an Yb:YAG laser, a diode laser, a fibre laser or the like.

The present case employs for example a fibre laser, in which a laser fibre-optic cable 61 having an inner fibre core 62 and an outer fibre core 63 is used, which is guided by a processing head that is provided here overall, including the welding optical unit 10, with the reference sign 60. Here, a movement device 70 of the welding apparatus 100 is arranged by way of example on the processing head 60, although it may alternatively or in addition also be provided on one or both workpieces 5. It is further possible to configure the welding optical unit 10 as a scanner optical unit. The processing head 60 can correspondingly be moved by the movement device 70 in the directions indicated for example by the double arrow 64, at least in an x-y plane of the x,y,z coordinate system indicated in FIG. 1. The beam propagation axis 2 coincides with the z axis.

In the example shown, the processing beam 1 is therefore guided with the aid of the laser fibre-optic cable 61 by the processing head 60, which directs the processing beam 1 onto the two workpieces 5 by means of a welding optical unit 10. The processing head 60 can be moved by means of the movement device 70 relative to the two workpieces 5 to be joined, which in the example shown may be arranged statically. Such a movement device 70 may for example be a robot arm or the like, on which the processing head 60 can be mounted. The processing head 60 and hence the processing beam I can therefore be moved in the example shown in FIG. 1 along a forward feed direction in the x-y plane of the x,y,z coordinate system.

During the movement along the forward feed direction, in the example shown in FIG. 1, a weld seam (not shown) that joins or welds the two workpieces 5 to one another is then formed by means of the processing beam 1 focused onto the two workpieces 5.

The welding optical unit 10 is arranged in or on the processing head 60. The welding optical unit 10 comprises a collimation lens 20 and a focusing lens 30 arranged behind the latter in the beam propagation direction 3 of the processing laser beam 1 along the beam propagation axis 2. Further, the welding optical unit 10 now comprises a pyramidal beamforming insert 40, which is arranged here by way of example between the laser fibre-optic cable 61 and the collimation lens 20. Alternatively, it is possible to arrange the pyramidal beamforming insert 40 between the collimation lens 20 and the focusing lens 30.

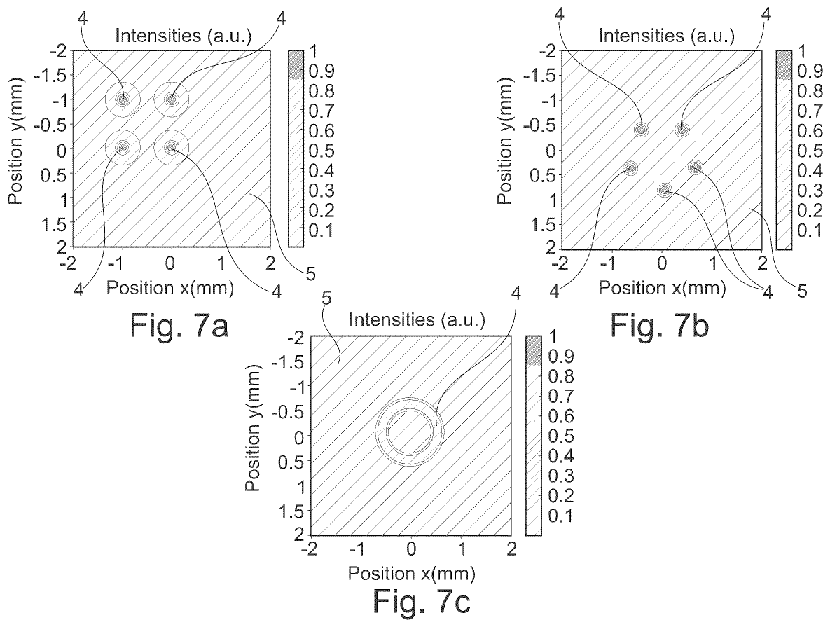

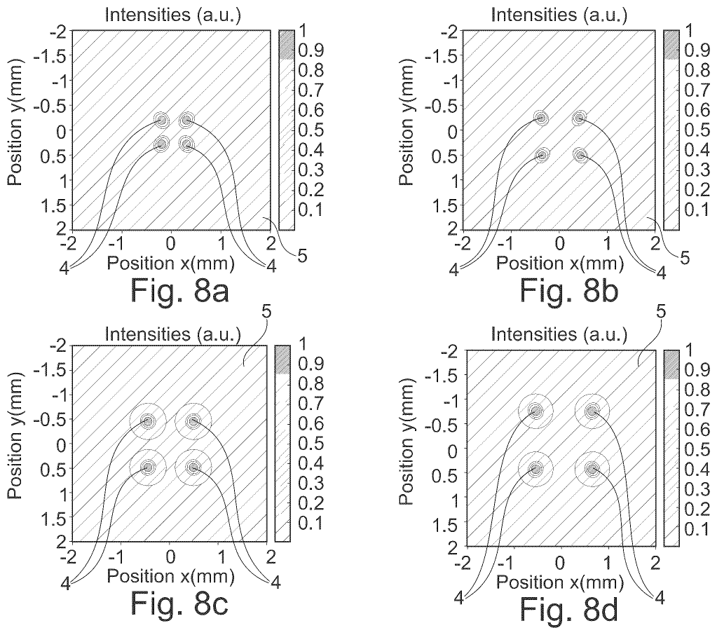

The pyramidal beamforming insert 40 is configured with a number k of side faces 41, where k=3 or >3. Each of these side faces 41 now ensures that the processing beam 1 is split into a number n=4 of spots on the workpiece 5 to be processed, as may be seen in FIGS. 7a, 7b and 8a to 8c.

Advantageously, a displacement device 50 is now provided, which is arranged on the beamforming insert 40 and makes it possible, in particular by a drive, to displace the pyramidal beamforming insert 40 in the directions indicated by the double arrow 51 along the z axis, or beam propagation axis 2, and therefore relative to the collimation lens 20. By this variation of the distance between the pyramidal beamforming insert 40 and the collimation lens 20, the spacings between the individual spots 4, or their beam axes, can be adjusted, as is shown in FIGS. 8a to 8d with the aid of different intensity distributions.

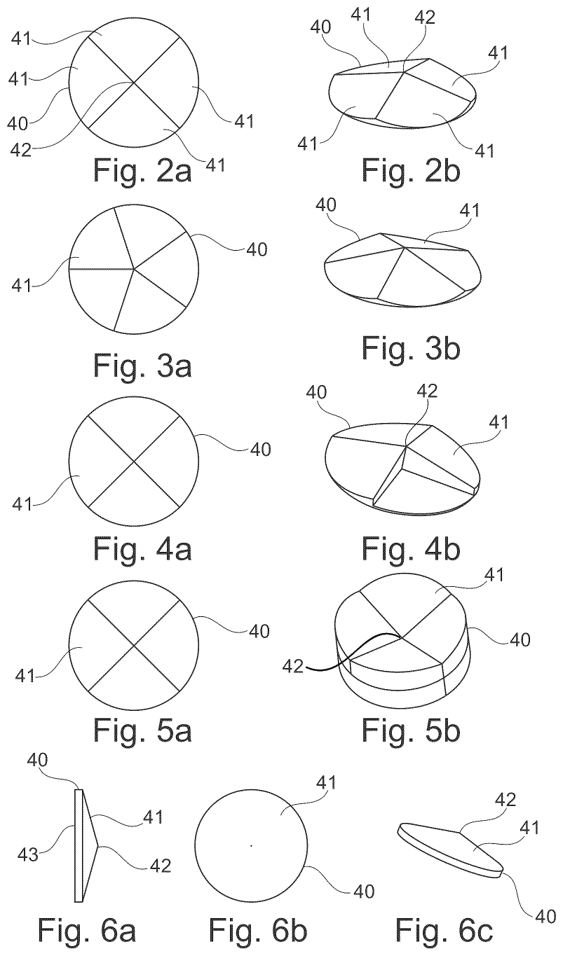

FIGS. 2a and 2b show different perspectives for a first possible exemplary embodiment of a pyramidal beamforming insert 40 for use in a welding optical unit 10 according to embodiments of the invention, or the welding apparatus 100 according to embodiments of the invention of FIG. 1.

The beamforming insert 40 comprises k=4 side faces 41 that extend upwards from the base face 43, which in the present case is round, in particular circular, and alternatively for example quadrilateral, for instance square, and converge at a common point 42. By the configuration of the beamforming insert 40 with a common point 42 in the form of an apex 42 on its pyramid shape (instead of a flat upper side or a plateau in the case of a frustopyramidal shape, by means of which a further spot 4 would be generated in the middle of the other spots 4) n=4 spots 4 are therefore generated from the processing beam 1 on the workpiece 5, as is shown in FIG. 7a, which shows an intensity distribution of the processing beam 1 of a welding optical unit 10 comprising the beamforming insert 40 of FIGS. 2a and 2b.

As now shown by FIGS. 8a to 8d, the intensity distribution, or the intensity profile, can be varied by varying the spacing between the individual spots 4 of the processing beam 1 on the workpiece 5, which is possible by means of the above-described displacement device 50.

FIGS. 3a and 3b show different perspectives of a second possible exemplary embodiment of a pyramidal beamforming insert 40 for use in a welding optical unit 10 according to embodiments of the invention, or the welding apparatus 100 according to embodiments of the invention of FIG. 1.

In contrast to the beamforming insert 40 of FIGS. 2a and 2b, it comprises in total five side faces 41. Correspondingly, the intensity profile shown in FIG. 7b with n=5 spots 4 is created on the workpiece 5.

The respective side faces 41 of the beamforming inserts 40 each have substantially the same size, so that the spots 4 are substantially equally intense, or large, so as to generate an optimum weld seam.

FIGS. 4a to 5b show two further different embodiments of beamforming inserts 40, although in comparison with the beamforming insert 40 of FIGS. 2a and 2b, in the beamforming insert 40 of FIGS. 4a and 4b one side face 41 has been omitted, or coincides with the base face 43, and the side faces 41 in the beamforming insert 40 of FIGS. 5a and 5b are directed towards the base face 43 i.e. inside the pyramid shape, instead of outside i.e. away from the base face 43, as in the beamforming inserts 40 of FIGS. 2a to 4b, so that the common point 42 is configured as an indentation 42.

FIGS. 6a to 6c lastly show a particular embodiment of a beamforming insert 40 in which there are quasi-infinitely many, or a large number of side faces 41, for example 20, 50, 100 or more, so that an axicon is formed. In the case of such an axicon beamforming insert 40, the processing beam 1 is transformed into a ring, as is shown by FIG. 7c with the aid of the corresponding intensity distribution for the processing beam 1 shaped with this beamforming insert 40.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A welding optical unit for shaping a processing beam of a processing head of a welding apparatus, the welding optical unit comprising:
a collimation lens,
a focusing lens, and
a beamforming insert for forming one or more spots of the processing beam on at least one workpiece to be processed, the beamforming insert having a base face and one or more side faces lying opposite the base face, which converge at a common point or in a common plateau of the beamforming insert.

2. The welding optical unit according to claim 1, wherein the one or more side faces substantially form a pyramid shape or a cone shape of the beamforming insert.

3. The welding optical unit according to claim 1, wherein each side face has a three-sided geometry.

4. The welding optical unit according to claim 1, wherein the one or more spots comprise three or more spots.

5. The welding optical unit according to claim 1, wherein the one or more spots comprise a substantially annular spot.

6. The welding optical unit according claim 1, wherein the beamforming insert is arranged before the collimation lens and the focusing lens in a beam propagation direction of the processing beam.

7. The welding optical unit according claim 1, wherein the beamforming insert is coupled with a displacement device that is adapted to displace the beamforming insert along a beam propagation axis of the processing beam and/or relative to the collimation lens.

8. The welding optical unit according claim 1, wherein a number of spots is at least equal to a number of side faces.

9. The welding optical unit according to claim 8, wherein the number of side faces is at least 4.

10. The welding optical unit according claim 1, wherein the beamforming insert is frustopyramidal or frustoconical.

11. The welding optical unit according to claim 1, wherein the common point is an apex or an indentation of the beamforming insert.

12. The welding optical unit according claim 1, wherein the base face of the beamforming insert is substantially planar.

13. The welding optical unit according claim 1, wherein the base face of the beamforming insert is a round base face.

14. A welding apparatus for joining at least two workpieces, the welding apparatus comprising a processing head for directing a processing beam onto the at least two workpieces and a welding optical unit according to claim 1.

15. The welding apparatus according to claim 14, wherein the processing head comprises a laser fibre-optic cable having an inner fibre core and an outer fibre core.

16. The welding apparatus according to claim 15, wherein the processing head further comprises a cable connector for the laser fibre-optic cable, which can be adjusted in relation to the collimation lens, and/or wherein the beamforming insert is adjustable in relation to the cable connector for the laser fibre-optic cable.
